(19) United States
(12) Patent Application Publication
(10) Pub. No.: US 2007/0220556 A1
(43) Pub. Date: Sep. 20, 2007

(54) Method and apparatus for watching DMB programs on a mobile terminal by direct channel input

(76) Inventors: Bong-Kun Kwack, Goyang-si (KR); Chil-Hyun Baek, Seoul (KR); Sung-Moo Hong, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,334

(22) Filed: Feb. 23, 2007

Related U.S. Application Data
(63) Continuation of application No. PCT/KR05/02812, filed on Aug. 25, 2005.

(30) Foreign Application Priority Data
Aug. 25, 2004 (KR) 10-2004-0067016

(51) Int. Cl. H04N 7/16; H04N 5/445; G06F 13/00

(52) U.S. Cl. 725/52; 725/39; 725/62

(57) ABSTRACT

Digital multimedia broadcasting watching method using direct input of DMB channel number in terminal and apparatus are disclosed. A method of receiving digital multimedia broadcasting (DMB) programs on a mobile terminal, comprises: recognizing a DMB channel number being input through a keypad of the mobile terminal; recognizing a DMB hotkey input proximate in time to the DMB channel number; checking if there exists a DMB channel corresponding to the DMB channel number; tuning to the DMB channel corresponding to the DMB channel number if the channel exists; and outputting a content being received through the DMB channel. According to the present invention, a user can access the DMB channel easily and conveniently by inputting a channel number directly

### RELATED APPLICATIONS

This application is a continuation application, and claims the benefit under 35 U.S.C. §§ 120 and 365 of PCT Application No. PCT/KR2005/002812, filed on Aug. 25, 2005, which is hereby incorporated by reference in its entirety.

### BACKGROUND OF THE INVENTION

1. Field of Invention

The present invention relates to DMB(Digital Multimedia Broadcasting), especially, method and apparatus for watching DMB program by inputting channel numbers on a mobile terminal.

2. Description of the Related Technology

DMB is a service of broadcasting digital multimedia data through satellite or territorial network. A user can watch DMB programs using a DMB-only terminal or a mobile terminal with a DMB receiver.

Generally, there is a Dedicated DMB button on the DMB receiver. When the user wants DMB services on the DMB receiver, then the user pushes the Dedicated DMB button.

In order to choose a DMB channel, the user searches or inputs a channel with pushing a Dedicated DMB button. When a Dedicated DMB button is pushed, EPG(Electronic Program Guide) data is executed, and then the user selects a channel by searching the EPG data. The EPG data, broadcasting guide data, is sent to the terminal for informing information relating to each channel such as a title of program, a time schedule, etc.

But, it may be inconvenient for those who already know the channel to enter a DMB service mode by pushing a certain key and searching channels. Also, along with the development of DMB services for improving convenience in use, various and easy user interfaces are required.

### SUMMARY OF CERTAIN INVENTIVE ASPECTS

The present invention is for overcoming the aforementioned problems. The present invention provides a method and apparatus for a user to directly input a channel number on mobile terminal in order to move to a desired channel easily and quickly.

To achieve aforementioned objects, according to one aspect of the present invention, there is provided a method and computer-readable medium for inputting a channel number directly for watching DMB(Digital Multimedia Broadcasting) programs on a mobile terminal, comprising: recognizing a DMB channel number being input through a keypad of the mobile terminal; recognizing a push of a DMB hotkey being successively input after the DMB channel number; checking if there exists a DMB channel corresponding to the input DMB channel number; tuning to the DMB channel corresponding to the DMB channel number if exists; and outputting a content being received through the DMB channel.

In one embodiment, the method further comprises executing EPG data if the DMB channel corresponding to the DMB channel number does not exists. And, the method further comprises executing the EPG data when the DMB hotkey is pushed without inputting the DMB channel number. The method further comprises executing the EPG data when the DMB hotkey is pushed for a predetermined short time without inputting the DMB channel number; and receiving a DMB content through a previous DMB channel that was selected before when the DMB hotkey is pushed for a predetermined long time without inputting the DMB channel number. The EPG data is received from a broadcasting center in advance and stored in a memory.

According to another aspect of the present invention, there is provided a mobile terminal for inputting a channel number directly for watching DMB(Digital Multimedia Broadcasting) program, comprising: a keypad with alphanumeric keys for a DMB channel number and a DMB hotkey; a DMB U/I (user interface), recognizing an input of the DMB channel number and a push of the DMB hotkey, checking if there exists a DMB channel corresponding to the DMB channel number, and requesting a reception of the DMB channel if exists; a tuner for channel tuning to receiving the DMB channel; and an output circuit for reproducing and outputting a content being received through the DMB channel.

Preferably, the DMB U/I executes EPG data if the DMB channel corresponding to the DMB channel number does not exist. And, the mobile terminal further comprises a memory for storing the EPG data being received from a broadcasting center.

Another aspect of the invention provides a method of watching DMB programs on a mobile terminal. The method comprises: recognizing a DMB channel number being input through a keypad of the mobile terminal; and recognizing a push of a DMB hotkey being input successively with the input of the DMB channel number. Recognizing a push of the DMB hotkey comes before or after recognizing the DMB channel number.

The method may further comprise: tuning to the DMB channel corresponding to the DMB channel number; and outputting content being received through the tuned DMB channel.

The DMB hotkey may be provided by a hard key in a keypad associated with the mobile terminal, or by a soft key in a display screen associated with the mobile terminal.

Still another aspect of the invention provides a mobile handset for watching DMB programs. The mobile handset comprises: a DMB hotkey; means for recognizing a DMB channel number being input through a keypad of the mobile terminal; and means for recognizing a push of a DMB hotkey being input successively with the input of the DMB channel number. Recognizing a push of the DMB hotkey comes before or after recognizing the DMB channel number.

The mobile handset may further comprise: means for tuning to the DMB channel corresponding to the DMB channel number; and means for outputting content being received through the tuned DMB channel. The DMB hotkey may comprise a hard key in a keypad associated with the mobile terminal or a soft key in a display screen associated with the mobile terminal

Hereinafter, the preferred embodiment of present invention will be described with accompanying drawings, and in describing drawings, same or corresponding member will have same reference number and repeated description will be omitted throughout whole drawings.

### BRIEF DESCRIPTION OF THE DRAWINGS

FIG. 1 shows a DMB network configuration according to an embodiment of the present invention, especially satellite DMB network.

FIG. 2 shows a DMB network configuration according to another embodiment of the present invention, especially territorial DMB network.

FIG. 3 is a block diagram of mobile terminal according to still another embodiment of the present invention.

FIG. 4 shows a keypad of the mobile terminal in FIG. 3.

FIG. 5 is a flowchart of inputting DMB channels directly for watching DMB programs according to still another embodiment of the present invention.

### DETAILED DESCRIPTION OF CERTAIN INVENTIVE EMBODIMENTS

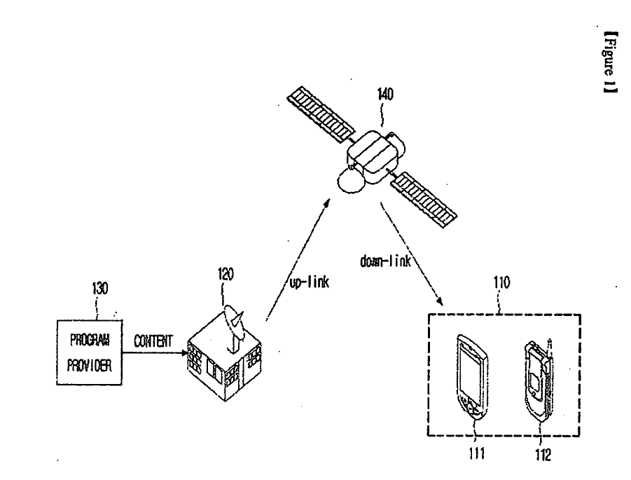

FIG. 1 shows DMB network configuration according to an embodiment of the present invention, satellite DMB network.

Referring to FIG. 1, the DMB network according to the present invention comprises a mobile terminal 110, a satellite 140, a DMB broadcasting center 120, and a program provider 130.

The mobile terminal 110 can receive a DMB signal and is a mobile communication terminal having DMB receiver or DMB-only terminal. The mobile terminal 110, as shown in FIG. 1, can be a PDA phone 111 or a cellular phone 112 with DMB receiver.

The program provider 130 is a server of a program provider who provides DMB content. The DMB broadcasting center 120 receives DMB contents from the program provider 130, and performs image processing on DMB contents such as compression, multiplexing etc., to transmit to the satellite 140. The DMB broadcasting center 120 is in charge of broadcasting such as management of channel data, program schedule data, etc. Also, on receiving a DMB request signal from the mobile terminal 110, the DMB broadcasting center 120 provides DMB channel corresponding to the request to the mobile terminal 110. Also, the DMB broadcasting center 120 can provide EPG data to the mobile terminal 110 as a response to the request from the mobile terminal or according to a certain schedule.

The satellite 140 delivers an uplink DMB signal from the DMB broadcasting center 120 to the mobile terminal 110.

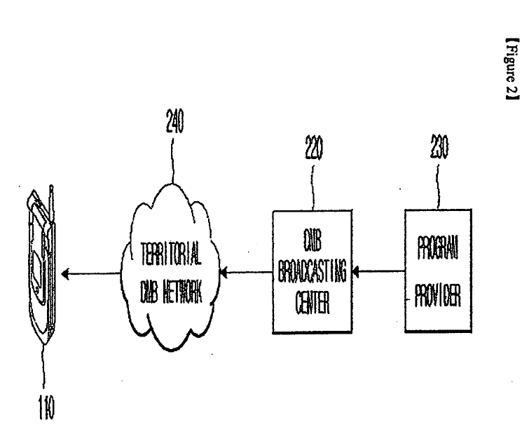

FIG. 2 shows DMB network configuration according to another embodiment of the present invention, especially territorial DMB network.

Referring to FIG. 2, the DMB network of another embodiment of the present invention comprises the mobile terminal 110, a territorial DMB network 240, a DMB broadcasting center 220, and a program provider 230.

Since the mobile terminal 110 and the program provider 230 are equivalent to the mobile terminal 110 and the program provider 130 in FIG. 1, the description is omitted.

The DMB broadcasting center 220 is also similar to the DMB broadcasting center 120. But, comparing to the DMB broadcasting center 120 in FIG. 1 that processes DMB content to transmit a DMB signal suitable for the satellite link, the DMB broadcasting center 220 in FIG. 2 processes the DMB content to transmit a DMB signal suitable for the territorial DMB network 240.

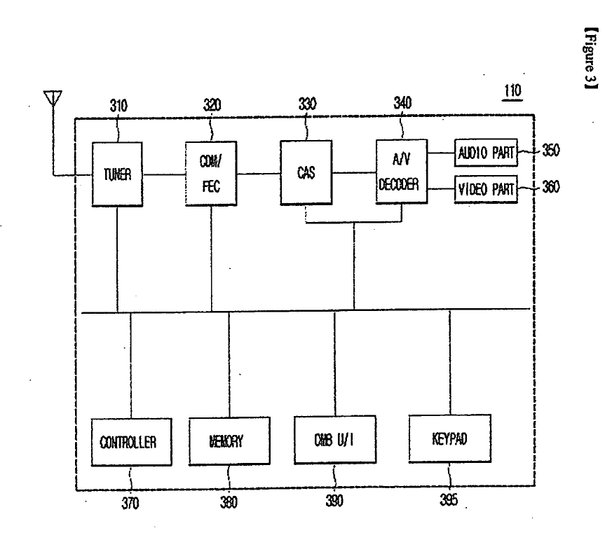

FIG. 3 is a block diagram of the mobile terminal according to the embodiment of the present invention.

Referring to FIG. 3, the mobile terminal 110 comprises a tuner 310, a CDM/FEC 320, a CAS 330, an A/V decoder 340, an audio part 350, a video part 360, a controller 370, a memory 380, a keypad 395 and a DMB U/I(User Interface) 390. The mobile terminal is assumed to be able to receive a satellite DMB signal.

The tuner 310 receives DMB RF signals through an antenna and comprises a LNA(Low Noise Amplifier), a filter, a mixer, etc.

The CDM/FEC 320 detects CDM(Code Division Multiplexing) signals from the RF signals being received by the tuner 310, and performs a de-spreading and an error correction.

The CAS 330 determines if a service subscriber has a right to use the service.

The A/V decoder 340 performs demultiplexing of DMB signals and decompresses video and audio signals, and comprises a demultiplexer, a MPEG decoder, etc.

The audio signal being decompressed by the A/V decoder 340 is sent to the audio part 350, and reproduced by the audio part 350 to be outputted through a speaker. The video signal being decompressed by the A/V decoder 340 is sent to the video part 360, and reproduced by the video part 360 to be displayed on a display such as LCD.

The controller 370 controls operations of the mobile terminal 110, and the memory 380 stores programs for operating the mobile terminal 110 and user data. The memory 380 can also store DMB contents or EPG data received from the DMB broadcasting center.

The DMB U/I 390 is a human interface for receiving DMB programs. Although the DMB U/I 390 is shown as an additional module in FIG. 3, actually DMB U/I software module is contained in the memory and performed by the controller 370 so that every function for user interface for receiving DMB programs becomes available.

The DMB U/I 390 recognizes a number for selecting DMB channels and a push of Dedicated DMB buttons on the keypad 395. More specifically, if a DMB channel number and the dedicated DMB button are input successively, the DMB U/I 390 checks if there exists a DMB channel corresponding to the DMB channel number. If there is DMB channel corresponding to the DMB channel number, the tuner 310 is tuned to the DMB channel to receive DMB program. Tuning the tuner 310 to the DMB channel corresponding to the channel number can be performed under the control of the controller 370. If there is no DMB channel corresponding to the channel number, then EPG data is executed. Preferably, EPG data is received from the broadcasting center in advance and stored in the memory 380. When EPG data is executed, a certain EPG screen is displayed and then the user can select a desired channel by navigating the EPG screen. On selecting channel, the controller 370 controls the tuner 310 to be tuned to the selected channel.

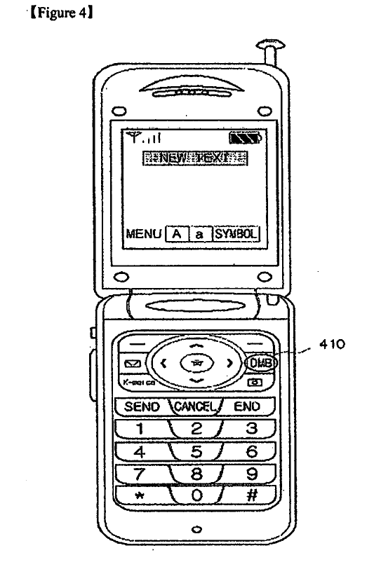

FIG. 4 shows the keypad of mobile terminal in FIG. 3. The mobile terminal in FIG. 4 has both mobile communication function and DMB receiving function. That is, it can be a cellular phone with a DMB receiver. Thus, keys in the cellular phone, e.g., numeric and alphabetical keys, a connect key and an end key are provided. And, the dedicated DMB button for receiving DMB, so-called ⊚MB hotkey⊚ must exist.

It is good not to assign any function except launching DMB mode on DMB hotkey.

When the DMB hotkey is pushed in an idle mode, the mobile terminal enters a standby mode for receiving a DMB channel. When a DMB hotkey is pushed, the mobile terminal executes EPG data for a user to search and select a desired channel. At this time, if the DMB hotkey is pushed for a short time (ie., a short keying), as described above, EPG data is executed, while if the DMB hotkey is pushed for a long time (ie., a long keying), a previous channel is selected.

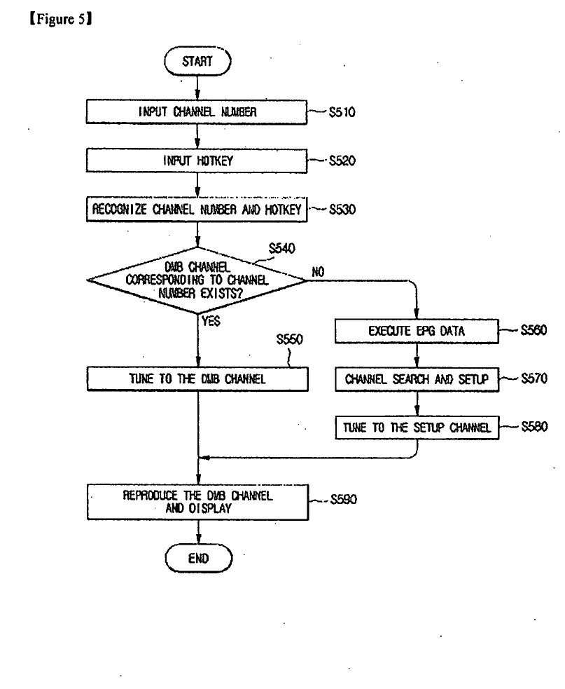

FIG. 5 is a flowchart of inputting DMB channel directly for watching DMB program according to the preferred embodiment of the present invention. The method of inputting DMB channels directly for watching DMB channel will be described with referring to FIG. 4 and FIG. 5.

If the DMB hotkey (410 in FIG. 4) is pushed successively right after DMB channel number, ie., a number in an idle mode (S510, S520), the mobile terminal recognizes the DMB channel number and the push of the DMB hotkey (S530). Then, the mobile terminal checks if there exists a DMB channel corresponding to the DMB channel number (S540). If there exists the DMB channel corresponding to the channel number, then the tuner is tuned to the DMB channel (S550). And, the mobile terminal outputs the content being received through the tuned DMB channel (S590). If there exists no DMB channel corresponding to the channel number, then EPG data is executed (S560). That is, it enables the user to search channels to select a desired channel by displaying the EPG screen. When the user selects one of channels by searching the EPG screen (S570), then the tuner is tuned to the selected DMB channel (S580). And, mobile terminal outputs the content being received through the tuned DMB channel (S590).

The present invention has been described with the embodiments. But, these embodiments are only for helping those skilled in the art to understand the present invention, the scope of the present invention to the aforementioned embodiments. The true scope of the present invention must be interpreted by following claims, and substitute or addition of equivalent element cannot depart from the spirit and scope of the present invention.

As described above, according to the present invention, a user can access the DMB channel easily and conveniently by inputting a channel number directly. Thus, the convenience for using DMB service increases and it will accelerate rapid development of DMB service.

While the above description has pointed out novel features of the invention as applied to various embodiments, the skilled person will understand that various omissions, substitution, and change in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of receiving digital multimedia broadcasting (DMB) programs on a mobile terminal, comprising:
recognizing a DMB channel number being input through a keypad of the mobile terminal;
recognizing a DMB hotkey input proximate in time to the DMB channel number;
checking if there exists a DMB channel corresponding to the DMB channel number;
tuning to the DMB channel corresponding to the DMB channel number if the channel exists;
receiving content on the DMB channel; and
displaying the content on the mobile terminal.

2. The method in claim 1, further comprising selecting a channel by searching electronic program guide (EPG) data if the DMB channel corresponding to the DMB channel number does not exist.

3. The method in claim 2, further comprising selecting a channel by searching the EPG data when the DMB hotkey is pushed without the input of the DMB channel number.

4. The method in claim 2, further comprising:
selecting a channel by searching the EPG data when the DMB hotkey is pushed for a predetermined time without the input of the DMB channel number; and
receiving DMB content through a previous DMB channel that was selected before the DMB hotkey is pushed for a predetermined longer time without the input of the DMB channel number.

5. The method in claim 2, wherein the EPG data has previously been received from a broadcasting center and stored in the mobile terminal.

6. A computer-readable medium including a program containing computer-executable instructions for performing the method for inputting a channel number directly for watching digital multimedia broadcasting (DMB) program on a mobile terminal, the method comprising:
recognizing a DMB channel number being input through a keypad of the mobile terminal;
recognizing a DMB hotkey input proximate in time to the DMB channel number;
checking if there exists a DMB channel corresponding to the DMB channel number;
tuning to the DMB channel corresponding to the DMB channel number if the channel exists;
receiving content on the DMB channel; and
displaying the content on the mobile terminal.

7. The computer-readable medium in claim 6, further comprising selecting a channel by searching electronic program guide (EPG) data if the DMB channel corresponding to the DMB channel number does not exist.

8. The computer-readable medium in claim 7, further comprising selecting a channel by searching the EPG data when the DMB hotkey is pushed without the input of the DMB channel number.

9. The computer-readable medium in claim 7, further comprising:
selecting a channel by searching the EPG data when the DMB hotkey is pushed for a predetermined time without the input of the DMB channel number; and
receiving DMB content through a previous DMB channel that was selected before the DMB hotkey is pushed for a predetermined longer time without the input of the DMB channel number.

10. The computer-readable medium in claim 7, wherein the EPG data has previously been received from a broadcasting center and stored in the mobile terminal.

11. A mobile terminal for inputting a channel number directly for watching digital multimedia broadcasting (DMB) program, comprising:
a keypad having keys for entering a DMB channel number and a DMB hotkey;
a DMB user interface configured to: recognize an input of the DMB channel number and a DMB hotkey input, check if there exists a DMB channel corresponding to the DMB channel number, and request a reception of the DMB channel if the channel exists;
a tuner for channel tuning to the DMB channel; and
a display for the content being received through the DMB channel.

12. The mobile terminal in claim 11, wherein the DMB user interface executes EPG data if the DMB channel corresponding to the DMB channel number does not exist.

13. The mobile terminal in claim 12, further comprising a memory for storing the EPG data being received from a broadcasting center.

14. A method of watching digital multimedia broadcasting (DMB) programs on a mobile terminal, comprising:
recognizing a DMB channel number being input through a keypad of the mobile terminal; and
recognizing a DMB hotkey input proximate in time to the input of the DMB channel number.

15. The method of claim 14, further comprising:
tuning to the DMB channel corresponding to the DMB channel number; and
displaying content being received through the tuned channel.

16. The method of claim 14, wherein the DMB hotkey is a hard key in a keypad associated with the mobile terminal.

17. The method of claim 14, wherein the DMB hotkey is a soft key in a display screen associated with the mobile terminal.

18. The method of claim 14, wherein recognizing a DMB hotkey input comes after recognizing the DMB channel number.

19. A mobile handset for watching digital multimedia broadcasting (DMB) programs, comprising:
a DMB hotkey;
means for recognizing a DMB channel number being input through a keypad of the mobile terminal; and
means for recognizing a DMB hotkey input proximate in time with the input of the DMB channel number,
wherein recognizing the DMB hotkey input comes after recognizing the DMB channel number.

20. The mobile handset of claim 19, further comprising:
means for tuning to the DMB channel corresponding to the DMB channel number; and
means for displaying content being received through the tuned channel.

21. The mobile handset of claim 19, wherein the DMB hotkey comprises a hard key in a keypad associated with the mobile terminal or a soft key in a display screen associated with the mobile terminal.
